(19) United States
(12) Patent Application Publication
(10) Pub. No.: US 2023/0316777 A1
(43) Pub. Date: Oct. 5, 2023

(54) IMAGE PROCESSING DEVICE AND IMAGE PROCESSING METHOD

(71) Applicant: Panasonic Intellectual Property Management Co., Ltd., Osaka (JP)

(72) Inventors: Ryo OTSUKI, Nara Ken (JP); Yoshimasa OKABE, Kanagawa Ken (JP); Koji SATO, Osaka Fu (JP)

(73) Assignee: Panasonic Intellectual Property Management Co., Ltd., Osaka (JP)

(21) Appl. No.: 18/104,985

(22) Filed: Feb. 2, 2023

(30) Foreign Application Priority Data
Mar. 30, 2022 (JP) 2022-057688

(51) Int. Cl. G06V 20/58; G06V 10/44

(52) U.S. Cl. CPC G06V 20/586; G06V 10/443

(57) ABSTRACT

The image processing device of the present disclosure generates an overhead view image in which a captured image capturing a periphery of a vehicle is converted into an image from a viewpoint above the vehicle, detects a straight line from the overhead view image, removes a straight line extending radially from the detected straight lines based on the position of a camera, and extracts a parking frame from the remaining straight lines. Accordingly, the image processing device compares the feature amount corrected based on the movement amount of the vehicle with the feature amount of the straight line of the overhead view image at a later time point, and removes the non-corresponding straight line to extract a parking frame and appropriately extract the parking frame.

### CROSS-REFERENCE TO RELATED APPLICATIONS

This application is based upon and claims the benefit of priority from Japanese Patent Application No. 2022-057688, filed on Mar. 30, 2022, the entire contents of which are incorporated herein by reference.

### FIELD

The present disclosure relates to an image processing device and an image processing method.

### BACKGROUND

In recent years, in a parking assistance device, there is a technique of detecting a parking frame line by converting a camera video into an overhead view video and extracting a straight line.

In a case where a camera video includes a three-dimensional object such as another vehicle or a sign, when the camera video is converted into an overhead view video, there is a possibility that the three-dimensional object portion is erroneously detected as a parking frame line.

### BRIEF DESCRIPTION OF THE DRAWINGS

FIG. 1A is a schematic diagram illustrating an example of a side-viewed vehicle including an image processing device according to a first embodiment;

FIG. 1B is a schematic diagram illustrating an example of an overhead-viewed vehicle including the image processing device according to the first embodiment;

FIG. 2 is a block diagram illustrating an example of a configuration of a vehicle including the image processing device according to the first embodiment;

FIG. 3 is a diagram illustrating an example of an overhead view image according to the first embodiment;

FIG. 4 is a flowchart illustrating a parking frame detection processing procedure according to the first embodiment;

FIG. 5A is a diagram for explaining a method of detecting a parking frame line according to a second embodiment;

FIG. 5B is a diagram for explaining a method of detecting a parking frame line according to the second embodiment;

FIG. 5C is a diagram for explaining a method of detecting a parking frame line according to the second embodiment;

FIG. 5D is a diagram for explaining a method of detecting a parking frame line according to the second embodiment;

FIG. 5E is a diagram for explaining a method of detecting a parking frame line according to the second embodiment;

FIG. 6 is a flowchart illustrating a parking frame detection processing procedure according to the second embodiment;

FIG. 7A is a diagram for explaining a method of detecting a parking frame line according to a third embodiment;

FIG. 7B is a diagram for explaining a method of detecting a parking frame line according to the third embodiment;

FIG. 7C is a diagram for explaining a method of detecting a parking frame line according to the third embodiment;

FIG. 7D is a diagram for explaining a method of detecting a parking frame line according to the third embodiment;

FIG. 7E is a diagram for explaining a method of detecting a parking frame line according to the third embodiment;

FIG. 8 is a flowchart illustrating a parking frame detection processing procedure according to the third embodiment;

FIG. 9 is a flowchart illustrating a parking frame detection processing procedure according to a fourth embodiment; and

FIG. 10 is a flowchart illustrating a parking frame detection processing procedure according to a fifth embodiment.

### DETAILED DESCRIPTION

An image processing device according to the present disclosure includes one or more hardware processors configured to function as a generation unit, a detection unit, and a parking frame extraction unit. The generation unit generates an overhead view image in which a captured image capturing a periphery of a vehicle is converted into an image from a viewpoint above the vehicle. The detection unit detects a straight line from the overhead view image. The parking frame extraction unit extracts a parking frame based on straight lines obtained by excluding straight lines matching a predetermined removal condition among straight lines detected by the detection unit. It is an object of the present disclosure to appropriately detect a parking frame line from an overhead view image.

### First Embodiment

First embodiment will be described with reference to the drawings.

Configuration Example of Vehicle

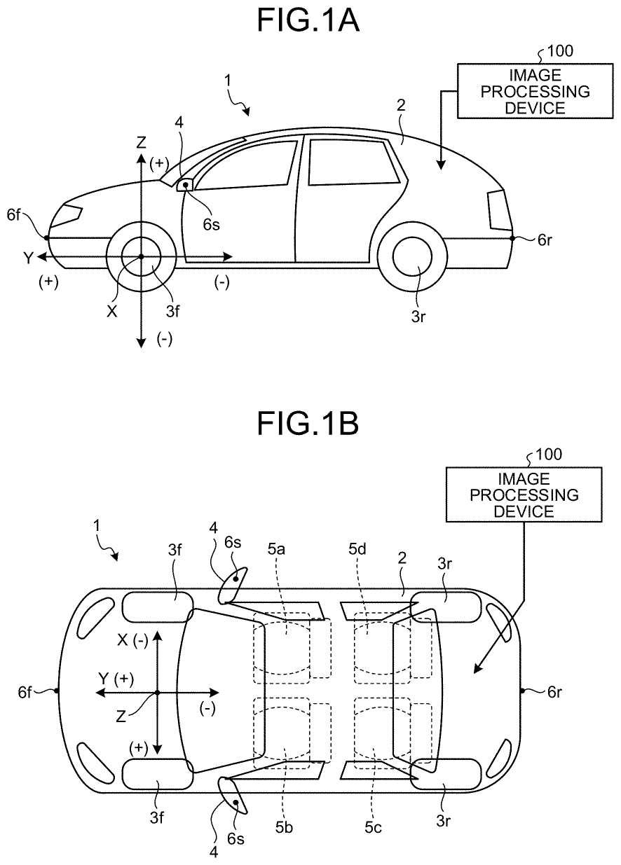

FIG. 1A and FIG. 1B are each a schematic diagram illustrating an example of a vehicle 1 including an image processing device 100 according to an embodiment. FIG. 1A is a side view of the vehicle 1, and FIG. 1B is a top view of the vehicle 1.

As illustrated in FIGS. 1A and 1B, the vehicle 1 includes a vehicle body 2 and two pairs of wheels 3 (a pair of front tires 3f and a pair of rear tires 3r) disposed on the vehicle body 2 along the vehicle length direction (±Y direction) of the vehicle body 2. The paired two front tires 3f and the paired two rear tires 3r are respectively disposed along the vehicle width direction (±X direction orthogonal to the ±Y direction) of the vehicle body 2.

The vehicle 1 includes a pair of door mirrors 4 at both ends of the vehicle body 2 in the ±X direction, close to the front tires 3f of the vehicle body 2 in the ±Y direction, and at a predetermined height position in the vehicle height direction (±Z direction orthogonal to the ±X direction and the ±Y direction).

The vehicle 1 includes a plurality of seats 5a to 5d inside the vehicle body 2. The seats 5a and 5b are disposed close to the front tires 3f and side by side in the ±X direction. The seats 5c and 5d are disposed close to the rear tires 3r and side by side in the ±X direction. The seat 5c is disposed behind the seat 5b, and the seat 5d is disposed behind the seat 5a. Note that the number and arrangement of the seats 5 included in the vehicle 1 are not limited to the example of FIGS. 1A and 1B.

The vehicle 1 includes a plurality of cameras 6s, 6f, and 6r on a predetermined end surface of the vehicle body 2. The cameras 6s, 6f, and 6r as imaging units are visible light cameras, CCD cameras capable of detecting light in a wider range, CMOS cameras, or other cameras. The cameras 6s, 6f, and 6r are preferably provided with wide-angle lenses.

The camera 6s is disposed on each of the two door mirrors 4 with, for example, a lens facing downward. As described above, the camera 6s is a camera that captures in the left-right direction of the vehicle 1. The camera 6f is disposed on an end surface of the vehicle body 2 on the front tire 3f side with, for example, a lens facing obliquely downward. As described above, the camera 6f is a camera that captures in the front-rear direction of the vehicle 1. The camera 6r is disposed on an end surface of the vehicle body 2 on the rear tire 3r side with, for example, a lens facing obliquely downward. Images of the surroundings of the vehicle body 2, including the road surface, are captured by the cameras 6s, 6f, and 6r.

Note that, in the present description, an end surface of the vehicle body 2 on the front tire 3f side may be referred to as a front surface. An end surface of the vehicle body 2 on the rear tire 3r side may be referred to as a rear surface. Both end surfaces of the vehicle body 2 in the ±X direction may be referred to as side surfaces. In a state of being seated on any of the seats 5a to 5d in the vehicle 1, a side surface corresponding to the right side may be referred to as a right side surface, and a side surface corresponding to the left side may be referred to as a left side surface.

In the present description, a direction toward the left side surface of the vehicle body 2 is defined as the +X direction, and a direction toward the right side surface of the vehicle body is defined as the −X direction. A direction toward the front surface side of the vehicle body 2 is defined as the +Y direction, and a direction toward the rear surface side of the vehicle body is defined as the −Y direction. A direction toward an upper side of the vehicle body 2 is defined as the +Z direction, and a direction toward a lower side (road surface side) of the vehicle body is defined as the −Z direction.

In the present description, when the vehicle 1 is stopped on a road surface having an ideal plane, an axis (X axis) in the ±X direction of the vehicle 1 and an axis (Y axis) in the ±Y direction of the vehicle 1 are parallel to the road surface, and an axis (Z axis) in the ±Z direction of the vehicle 1 is parallel to the normal line with respect to the road surface.

The vehicle 1 can travel by using the two pairs of wheels 3 disposed along the ±Y directions. In this case, the ±Y direction in which the two pairs of wheels 3 are disposed is the traveling direction (moving direction) of the vehicle 1, and the vehicle can move forward (travel in the +Y direction) or backward (travel in the −Y direction) by switching gears, for example. The vehicle can also make right or left turn by steering.

The image processing device 100 is mounted in the vehicle 1, for example, and performs predetermined conversion on images from the cameras 6s, 6f, and 6r. The image conversion is, for example, processing of converting a viewpoint so that an image of a road surface captured by the cameras 6s, 6f, and 6r from obliquely above becomes an image from directly above (overhead view image). Thus, the image can be used for predetermined processing such as parking assistance processing. As described above, the overhead view image is an image converted into an image from a viewpoint above the vehicle 1.

Configuration Example of Image Processing Device

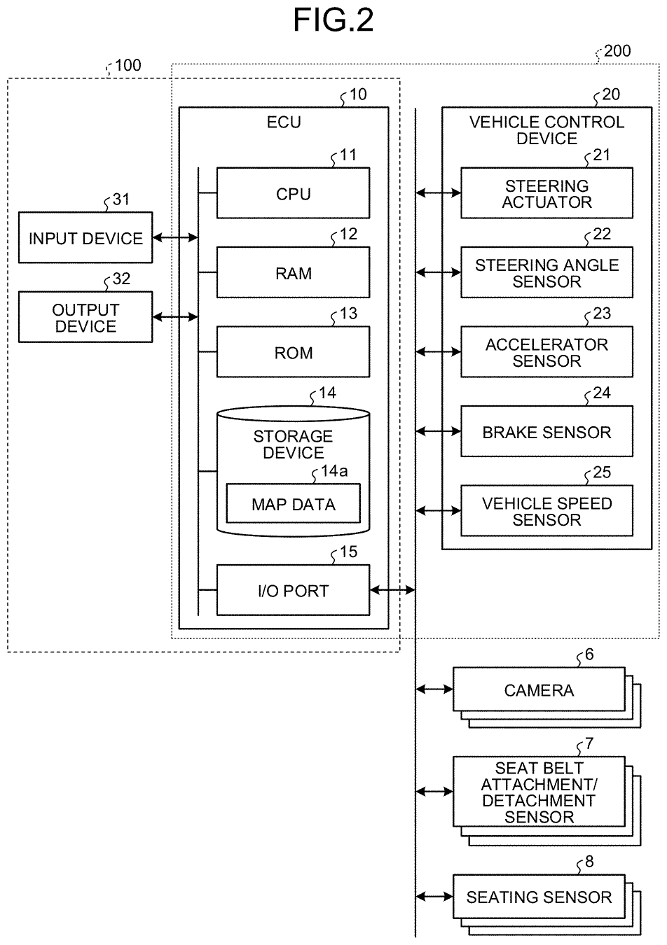

FIG. 2 is a block diagram illustrating an example of a configuration of the vehicle 1 including the image processing device 100 according to the embodiment. As illustrated in FIG. 2, the vehicle 1 includes the image processing device 100 and a parking assistance device 200.

The image processing device 100 includes an electronic control unit (ECU) 10, an input device 31, and an output device 32. However, the image processing device 100 may include the camera 6 (cameras 6s, 6f, and 6r in FIGS. 1A and 1B), a seat belt attachment/detachment sensor 7, and a seating sensor 8. The parking assistance device 200 includes the ECU 10 and a vehicle control device 20. However, the parking assistance device 200 may include the camera 6, the input device 31, and the output device 32.

The ECU 10 is configured as a computer including, for example, a central processing unit (CPU) 11, a random-access memory (RAM) 12, and a read only memory (ROM) 13. A storage device 14 composed of, for example, a hard disk drive (HDD) may be built in the ECU 10. The ECU 10 includes an input/output (I/O) port 15 capable of transmitting and receiving detection signals and various kinds of information to and from various sensors and others.

The components of the ECU 10, which are the RAM 12, the ROM 13, the storage device 14, and the I/O port 15, are configured to be able to transmit and receive various kinds of information to and from the CPU 11 via an internal bus, for example.

The ECU 10 controls parking assistance processing such as detection processing of a parking section and calculation processing of a parking path to the parking section by the CPU 11 executing a program installed in the ROM 13. The ECU 10 controls image processing such as conversion of an image from the above-described camera 6 by the CPU 11 executing a program installed in the ROM 13. The converted image is used for, for example, detection processing of a parking section in parking assistance processing. The ECU 10 controls processing of outputting the converted image to the output device 32, which will be described below.

The storage device 14 stores, for example, calibration data (not illustrated) and map data 14a.

The calibration is performed on the camera 6 at the time of, for example, factory shipment of the vehicle 1 in order to cancel an attachment error or other errors of the camera 6 occurring at the time of manufacturing the vehicle 1. By performing the calibration, the normal line with respect to the road surface, the plane parallel to the road surface, and the height position (position in the vertical direction) of the road surface are determined in common in the viewpoint (image) of each individual camera 6 even when there is a slight variation in the posture of the camera 6 at the time of attachment. The calibration data includes information such as the normal line with respect to the road surface, the plane parallel to the road surface, and the height position of the road surface, which serve as a reference at the time of image processing of the camera 6.

The map data 14a includes occupant arrangement information indicating a seating state of an occupant on the plurality of seats 5 (e.g., seats 5a to 5d in FIG. 1B) in the vehicle 1. The seating state of the occupant is, for example, the number of occupants in the vehicle 1 and the seating positions on the plurality of seats 5, that is, the arrangement of the occupants. Each of a plurality of pieces of occupant arrangement information indicating different numbers of occupants and occupant arrangements is associated with an image conversion parameter used when the ECU 10 converts an image from the camera 6. Each of the image conversion parameters has a different set value according to the number of occupants and the occupant arrangement of the occupant arrangement information with which the image conversion parameter is associated.

The vehicle control device 20 includes a steering actuator 21, a steering angle sensor 22, an accelerator sensor 23, a brake sensor 24, and a vehicle speed sensor 25. The vehicle control device 20 acquires information indicating a state of each portion of the vehicle 1 from the steering angle sensor 22, the accelerator sensor 23, the brake sensor 24, the vehicle speed sensor 25, and other sensors. Based on these pieces of information, the vehicle control device 20 controls the steering actuator 21 while receiving an operation of an accelerator, a brake, and others by a driver, thereby performing parking assistance for parking the vehicle 1 in the above-described parking section, for example.

The seat belt attachment/detachment sensor 7 is a sensor that detects that an occupant is seated on the seat 5 of the vehicle 1. The seat belt attachment/detachment sensor 7 is attached to a seat belt provided in each seat 5 and detects attachment/detachment of the seat belt to which the seat belt attachment/detachment sensor is attached. The seat belt attachment/detachment sensor 7 detects the seating of the occupant on the seat 5 by detecting the attachment of the seat belt.

The seating sensor 8 is, for example, a load sensor that detects a load, is attached to each seat 5 in the vehicle 1, and detects a weight applied to the seat 5 to which the seating sensor is attached. In other words, the seating sensor 8 can also detect that the occupant is seated on a predetermined seat 5.

The ECU 10 receives, for example, a signal from the seat belt attachment/detachment sensor 7 and determines the number of occupants and seating positions in the vehicle 1. The ECU 10 selects occupant arrangement information that matches the determined number of occupants and the determined seating position from among the plurality of pieces of occupant arrangement information in the above-described map data 14a, thereby reading out the image conversion parameter associated with the selected occupant arrangement information from the storage device 14 and using the image conversion parameter for image conversion.

However, instead of or in addition to the seat belt attachment/detachment sensor 7, a signal from the seating sensor 8 may be used to determine the number of occupants and seating position in the vehicle 1.

The components provided in the vehicle control device 20 such as the steering actuators 21, the steering angle sensor 22, the accelerator sensor 23, the brake sensor 24, and the vehicle speed sensor 25, the camera 6, the seat belt attachment/detachment sensor 7, and the seating sensor 8 are connected to the I/O port 15 of the ECU 10 via a bus. A bus that connects these components may be, for example, a controller area network (CAN) bus.

The output device 32 as a display unit is, for example, a display device such as a liquid crystal monitor which is mounted in the vehicle 1 and can be visually recognized by an occupant in the vehicle 1. The display device displays, for example, an image captured by the camera 6 and converted by the ECU 10. In other words, the image processing device 100 including the output device 32 also functions as an image output device that outputs a processed image.

The input device 31 is, for example, a touch panel formed integrally with a liquid crystal monitor, and receives an input operation by an occupant in the vehicle 1. The occupant can instruct the image processing device 100 to display an image via the input device 31 or instruct the parking assistance device 200 to start parking assistance processing.

Note that the configurations of the input device 31 and the output device 32 are not limited to those described above, and the input device 31 and the output device 32 may be separate devices.

The image processing device 100 converts an image from the camera 6 into an overhead view image, extracts a straight line from the overhead view image, and identifies a parking frame based on the extracted straight line. A case where not only a parking space but also a three-dimensional object such as another vehicle or a sign is included in an image will be considered. In this case, the portion of the three-dimensional object is a straight line in the overhead view image. As a result, there is a possibility that a straight line caused by a three-dimensional object may be erroneously detected as a parking frame line.

Therefore, the image processing device 100 excludes the straight line caused by the three-dimensional object from the parking frame line candidate, and extracts a parking frame from the straight lines remaining after the exclusion.

As a result of converting the image from the camera 6 into the overhead view image, the image processing device 100 according to the first embodiment excludes, from the parking frame line candidates, the straight lines extending radially based on the imaging reference location, and detects a parking frame line.

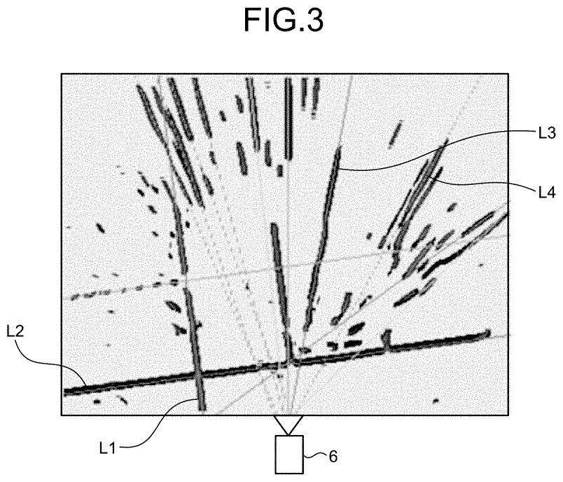

An example in which an image captured by the image processing device 100 is converted into an overhead view image is illustrated in FIG. 3. FIG. 3 is a diagram illustrating an example of an overhead view image. As illustrated in FIG. 3, the overhead view image includes a plurality of straight lines such as straight lines L1 to L4. The image processing device 100 detects straight lines such as the straight lines L1 to L4 from the overhead view image. In the case of a captured image including a three-dimensional object, in an overhead view image of the captured image, the three-dimensional object portion tends to be a straight line extending radially based on the position of the camera 6. In consideration of this point, the image processing device 100 excludes the straight lines extending radially from the parking frame line candidates and detects a parking frame line.

In the case of the example of FIG. 3, the straight line L3 and the straight line L4 extend radially, and the image processing device 100 excludes these straight lines from the parking frame line candidates. The image processing device 100 detects straight lines extending radially by determining whether or not the intercept of the target straight line matches the position of the camera 6. As a method of detecting a straight line extending radially, the image processing device 100 may determine that the straight line is a straight line extending radially when there is no straight line parallel or perpendicular to the target straight line.

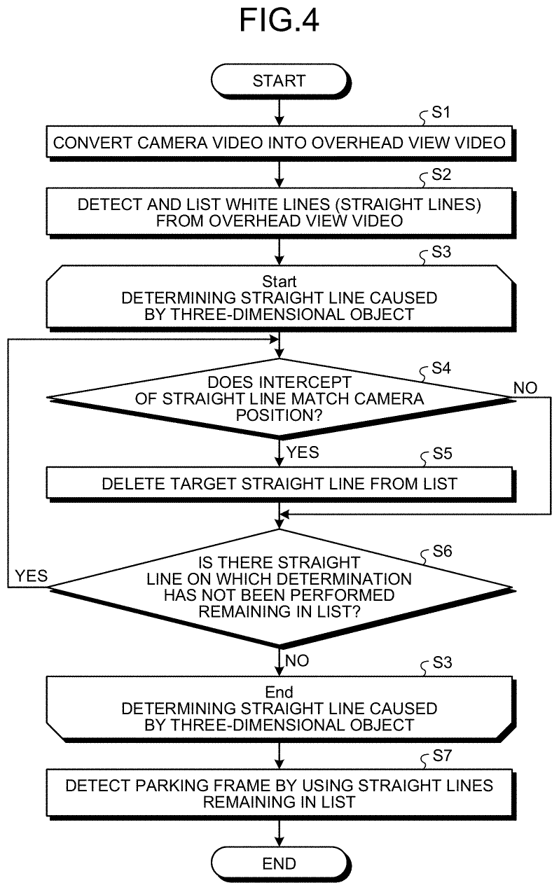

A processing procedure for detecting a parking frame according to the first embodiment will then be described with reference to a flowchart illustrated in FIG. 4. FIG. 4 is a flowchart illustrating a processing procedure for detecting a parking frame according to the first embodiment.

The image processing device 100 converts the captured image/video (camera image/video) acquired from the camera 6 into an overhead view image (overhead view video) (step S1). The image processing device 100 then detects and lists white lines (straight lines) from the overhead view image (step S2). The image processing device 100 then performs loop processing to determine a straight line caused by the three-dimensional object in the overhead view image (step S3).

The image processing device 100 performs loop processing for each of the listed straight lines. In the loop processing, the processing of step S4 to step S6 is performed. In step S4, it is determined whether or not the intercept of the target straight line matches the camera position, and if the intercept matches the camera position (step S4: Yes), the target straight line is deleted from the list (step S5) and the process proceeds to step S6. In other words, the image processing device 100 determines that the straight line is a straight line extending radially. It is determined whether or not the intercept of the target straight line matches the camera position, and if the intercept does not match the camera position (step S4: No), the target straight line is not deleted from the list and the process proceeds to step S6.

If there is a straight line on which the determination processing of step S4 has not been performed among the straight lines in the list (step S6: Yes), the image processing device 100 proceeds to step S4 and performs the determination processing on the straight line on which the determination processing is not performed. If there is no straight line on which the determination processing of step S4 has not been performed among the straight lines in the list (step S6: No), the loop processing is ended, and the process proceeds to step S7. In step S7, the image processing device 100 detects a parking frame by using the straight lines remaining in the list (step S7).

The image processing device 100 according to the first embodiment generates an overhead view image in which a captured image capturing the periphery of the vehicle 1 is converted into an image from a viewpoint above the vehicle 1, detects a straight line from the overhead view image, removes a straight line extending radially from the detected straight line based on the position of the camera 6, and extracts a parking frame from the remaining straight lines.

As described above, the image processing device 100 removes the straight line caused by the three-dimensional object among the straight lines detected from the overhead view image to extract a straight line of the parking frame, and thus can more appropriately extract the parking frame.

### Second Embodiment

The image processing device 100 according to a second embodiment identifies a straight line caused by a three-dimensional object by comparing overhead view images obtained by converting a plurality of captured images during movement of the vehicle 1, excludes the identified straight line from parking frame line candidates, and extracts a parking frame from the straight lines remaining after the exclusion.

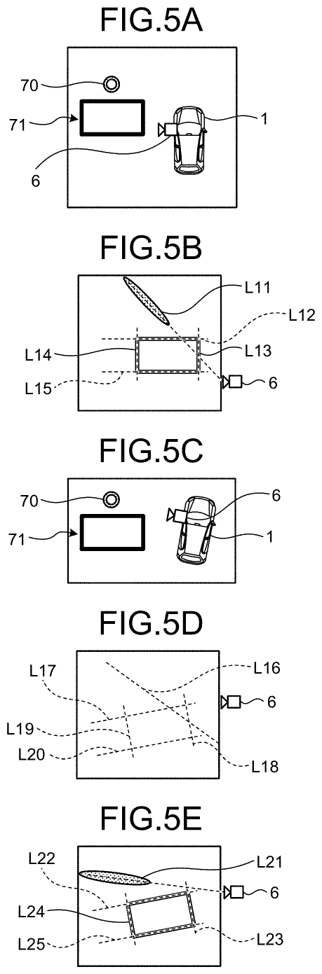

A method of detecting a parking frame line by the image processing device 100 according to the second embodiment will now be described with reference to FIGS. 5A to 5E. FIG. 5 is a diagram for explaining a method of detecting a parking frame line by the image processing device 100 according to the second embodiment.

FIG. 5A illustrates a positional relationship among the vehicle 1, a three-dimensional object 70, and a parking frame 71 at a certain time point during movement. In the vehicle 1, an image is captured by the camera 6 at a position illustrated in FIG. 5A. The image processing device 100 converts a captured image into an overhead view image. FIG. 5B is an example of an overhead view image based on the image captured at the position of FIG. 5A. The image processing device 100 detects straight lines L11 to L15 from the overhead view image.

The straight line L11 is a straight line corresponding to the three-dimensional object 70. The straight lines L12 to L15 are straight lines corresponding to the parking frame 71. The image processing device 100 calculates the feature amount of a detected straight line. The feature amount mentioned here is the position, angle and length of a straight line.

FIG. 5C illustrates the positional relationship among the vehicle 1, the three-dimensional object 70, and the parking frame 71 at a time point after that in FIG. 5A. The vehicle 1 is moving in the right-oblique direction from the position illustrated in FIG. 5A. The image processing device 100 acquires the movement amount of the vehicle 1. For example, the image processing device 100 acquires the movement amount based on current position information obtained by various devices of the vehicle control device 20 or a GPS receiver not illustrated.

The image processing device 100 estimates a straight line extracted when a captured image captured at the time of FIG. 5C is converted into an overhead view image based on the movement amount. The image processing device 100 obtains the above estimated result by correcting the feature amount of the straight line of the overhead view image of FIG. 5B based on the movement amount. FIG. 5D illustrates a result obtained by correcting the feature amount of the straight line of the overhead view image of FIG. 5B based on the movement amount.

Straight lines L16 to L20 illustrated in FIG. 5D are obtained by correcting the feature amount of each of the straight lines L11 to L15 illustrated in FIG. 5B based on the movement amount.

The image processing device 100 converts the image captured at the time of FIG. 5C into an overhead view image. FIG. 5E is an example of an overhead view image based on the image captured at the position of FIG. 5C. The image processing device 100 detects straight lines L21 to L25 from the overhead view image. The image processing device 100 calculates the feature amount of each of the straight lines L21 to L25. The image processing device 100 then compares the feature amounts of the straight lines L16 to L20 illustrated in FIG. 5D with the feature amounts of the straight lines L21 to L25 illustrated in FIG. 5E. The image processing device 100 determines that the straight lines L17 to L20 correspond to the straight lines L22 to L25, respectively. The image processing device 100 then determines that the straight line L16 does not correspond to the straight line L21 because the angle of the straight line L16 is different from that of the straight line L21. The image processing device 100 further determines that the straight line L16 does not correspond to the other straight lines L22 to L25. The image processing device 100 excludes the straight line L16 corresponding to the straight line L11 of FIG. 5D from the parking frame line candidates, and extracts a parking frame from the straight lines L12 to L15 remaining after the exclusion.

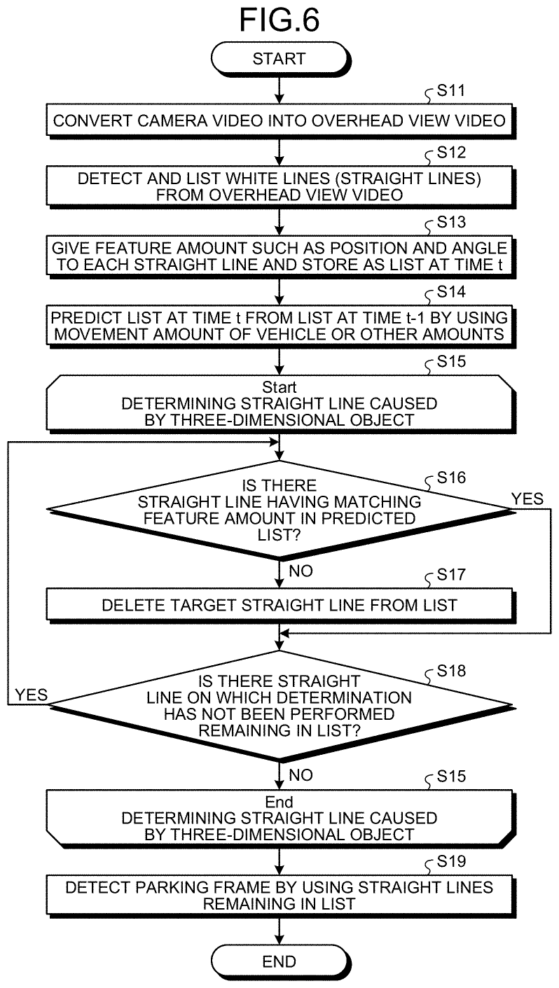

A processing procedure for detecting a parking frame according to the second embodiment will then be described with reference to a flowchart illustrated in FIG. 6. FIG. 6 is a flowchart illustrating a processing procedure for detecting a parking frame according to the second embodiment.

The image processing device 100 converts a captured image/video at each time point (e.g., time t−1 and time t) acquired from the camera 6 into an overhead view image/video (step S11). The image processing device 100 then detects and lists white lines (straight lines) from each of the overhead view images (step S12).

The image processing device 100 calculates the feature amount of the straight line detected from the overhead view image at time t−1. The image processing device 100 calculates the feature amount of the straight line detected from the overhead view image at time t and gives the feature amount such as a position and an angle to each straight line and stores as a list at time t (step S13). The image processing device 100 predicts a list at time t from a list at time t−1 by using the movement amount of the vehicle 1 or other amounts. The image processing device 100 corrects the feature amount of the straight line detected from the overhead view image at time t−1 based on the movement amount of the vehicle 1 from time t−1 to time t (step S14).

The image processing device 100 then performs loop processing to determine a straight line caused by the three-dimensional object in the overhead view image (step S15).

The image processing device 100 performs loop processing for each of the listed straight lines. In the loop processing, the processing of step S16 to step S18 is performed. In step S16, it is determined if there is a straight line having a matching feature amount in the predicted list and whether or not the feature amount of the straight line obtained by correcting the target straight line (straight line at time t−1) matches the straight line at time t. If the feature amount does not match the straight line (step S16: No), the target straight line is deleted from the list (step S17) and the process proceeds to step S18. In other words, the image processing device 100 determines that the straight line is a straight line to be excluded from the parking frame candidates. It is determined whether or not the feature amount of the straight line obtained by correcting the target straight line (straight line at time t−1) matches the straight line at time t, and if the feature amount matches the straight line (step S16: Yes), the target straight line is not deleted from the list and the process proceeds to step S18.

If there is a straight line on which the determination processing of step S16 has not been performed among the straight lines in the list (step S18: Yes), the image processing device 100 proceeds to step S16 and performs the determination processing on the straight line on which the determination processing is not performed. If there is no straight line on which the determination processing of step S16 has not been performed among the straight lines in the list (step S18: No), the loop processing is ended, and the process proceeds to step S19. In step S19, the image processing device 100 detects a parking frame by using the straight lines remaining in the list (step S19).

The image processing device 100 according to the second embodiment calculates the feature amount of the straight line detected from the overhead view image of the captured image at a certain time point in the vehicle 1 during movement, corrects the feature amount based on the movement amount, and calculates the feature amount of the straight line detected from the overhead view image of the captured image at a time point after the above time point. If there is no feature amount of the straight line of the overhead view image at a later time point, which corresponds to the feature amount after the correction, the image processing device 100 removes the straight line having the feature amount after the correction and extracts a parking frame from the remaining straight lines.

As described above, the image processing device 100 compares the feature amount corrected based on the movement amount of the vehicle with the feature amount of the straight line of the overhead view image at a later time point, and removes the non-corresponding straight line to extract a parking frame, and thus can appropriately extract the parking frame.

### Third Embodiment

The image processing device 100 according to a third embodiment identifies a straight line caused by a three-dimensional object by comparing overhead view images obtained by converting captured images in a plurality of directions of the vehicle 1, excludes the identified straight line from parking frame line candidates, and extracts a parking frame from the straight lines remaining after the exclusion.

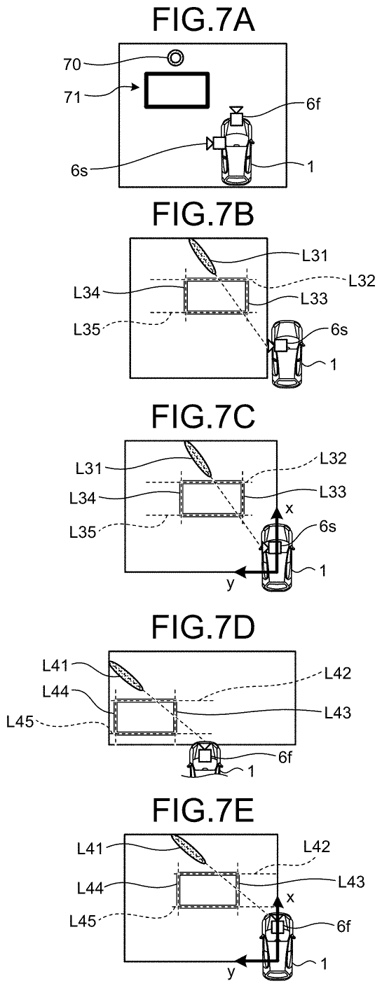

A method of detecting a parking frame line by the image processing device 100 according to the third embodiment will now be described with reference to FIGS. 7A to 7E. FIG. 7 is a diagram for explaining a method of detecting a parking frame line by the image processing device 100 according to the third embodiment.

FIG. 7A illustrates a positional relationship among the vehicle 1, the three-dimensional object 70, and the parking frame 71. In the vehicle 1, the camera 6s (camera that captures in the left-right direction of the vehicle 1) captures an image at a position illustrated in FIG. 7A. The image processing device 100 converts a captured image into an overhead view image. FIG. 7B is an example of an overhead view image based on the image captured by the camera 6s at the position of FIG. 7A. The image processing device 100 detects straight lines L31 to L35 from the overhead view image.

The straight line L31 is a straight line corresponding to the three-dimensional object 70. The straight lines L32 to L35 are straight lines corresponding to the parking frame 71. The image processing device 100 calculates the feature amount of a detected straight line.

The image processing device 100 then corrects the feature amounts of the straight lines L31 to L35 so as to be the reference position of the rear portion of the vehicle 1 as illustrated in FIG. 7C.

In the vehicle 1, the camera 6f (camera that captures in the front-rear direction of the vehicle 1) captures an image at a position illustrated in FIG. 7A. The image processing device 100 converts a captured image into an overhead view image. FIG. 7D is an example of an overhead view image based on the image captured by the camera 6f at the position of FIG. 7A. The image processing device 100 detects straight lines L41 to L45 from the overhead view image.

The straight line L41 is a straight line corresponding to the three-dimensional object 70. The straight lines L42 to L45 are straight lines corresponding to the parking frame 71. The image processing device 100 calculates the feature amount of a detected straight line.

The image processing device 100 then corrects the feature amounts of the straight lines L41 to L45 so as to be the reference position (similar to the reference position illustrated in FIG. 7C) of the rear portion of the vehicle 1 as illustrated in FIG. 7E.

The image processing device 100 then compares the feature amounts of the straight lines L31 to L35 illustrated in FIG. 7C with the feature amounts of the straight lines L41 to L45 illustrated in FIG. 7E. The image processing device 100 determines that the straight lines L32 to L35 correspond to the straight lines L42 to L45, respectively. The image processing device 100 then determines that the straight line L31 does not correspond to the straight line L41 because the angle of the straight line L31 is different from that of the straight line L41. The image processing device 100 further determines that the straight line L31 does not correspond to the other straight lines L42 to L45. The image processing device 100 excludes the straight line L31 of FIG. 7B from the parking frame line candidates and extracts a parking frame from the straight lines L32 to L35 remaining after the exclusion.

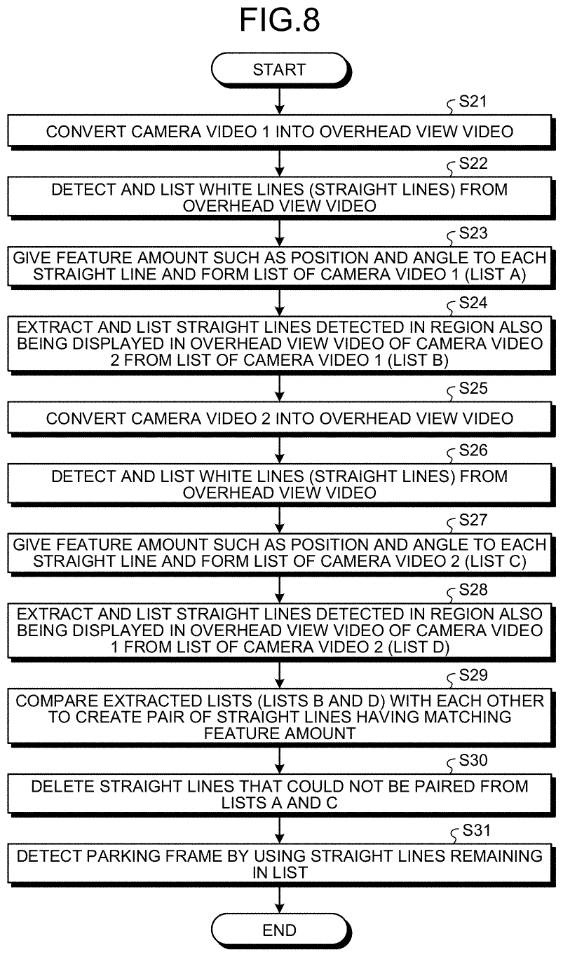

A processing procedure for detecting a parking frame according to the third embodiment will then be described with reference to a flowchart illustrated in FIG. 8. FIG. 8 is a flowchart illustrating a parking frame detection processing procedure according to the third embodiment.

The image processing device 100 converts each captured image (camera video 1) acquired from the camera 6s into an overhead view image/video (step S21). The image processing device 100 then detects and lists white lines (straight lines) from the overhead view image (step S22). The image processing device 100 then calculates the feature amounts of the listed straight lines and gives the feature amount such as a position and an angle to each straight line and forms a list of camera video 1 as list A (step S23). The image processing device 100 extracts and lists straight lines detected in a region also being displayed in the overhead view video of camera video 2 from the list of the camera video 1 as list B. The image processing device 100 then generates a list in which the feature amount of the straight line of the portion overlapping with the imaging range of the camera 6f among the straight lines detected from the above overhead view image is corrected in accordance with the reference position in the rear of the vehicle (step S24).

The image processing device 100 converts each captured image (camera video 2) acquired from the camera 6f into an overhead view image (step S25). The image processing device 100 then detects and lists white lines (straight lines) from the overhead view image/video (step S26). The image processing device 100 then calculates the feature amounts of the listed straight lines, and gives the feature amount such as a position and an angle to each straight line and forms a list of camera video 2 as list C (step S27). The image processing device 100 extracts and lists straight lines detected in a region also being displayed in the overhead view video of camera video 1 from the list of the camera video 2 as list D. The image processing device 100 then generates a list in which the feature amount of the straight line of the portion overlapping with the imaging range of the camera 6s among the straight lines detected from the above overhead view image is corrected in accordance with the reference position in the rear of the vehicle (step S28).

The image processing device 100 compares the list generated in step S24 with the list generated in step S28 (compares extracted lists as Lists B and D with each other) to create a pair of corresponding straight lines having a matching feature amount (step S29). The image processing device 100 deletes the straight line that could not be paired from the list (lists A and C) of steps S24 (step S30). The image processing device 100 detects a parking frame by using the straight lines remaining in the list (step S31).

The image processing device 100 according to the third embodiment calculates the feature amount of the straight line detected from the overhead view image of the captured image in the left-right direction of the vehicle 1, and calculates the feature amount of the straight line detected from the overhead view image of the captured image in the front-rear direction of the vehicle 1. If there is no feature amount of the straight line of the overhead view image at a later time point, which corresponds to the feature amount after the correction, the image processing device 100 removes the straight line having the feature amount after the correction and extracts a parking frame from the remaining straight lines.

As described above, the image processing device 100 compares the feature amount of the straight line detected from the overhead view image of the captured image in the left-right direction with the feature amount of the straight line of the overhead view image of the captured image in the front-rear direction, and removes the non-corresponding straight line to extract a parking frame, and thus can appropriately extract the parking frame.

### Fourth Embodiment

The image processing device 100 according to a fourth embodiment converts the captured image of the vehicle 1 into an overhead view image, further detects a three-dimensional object from the captured image, excludes straight lines in a region of the three-dimensional object in the overhead view image from parking frame line candidates, and extracts a parking frame from the straight lines remaining after the exclusion.

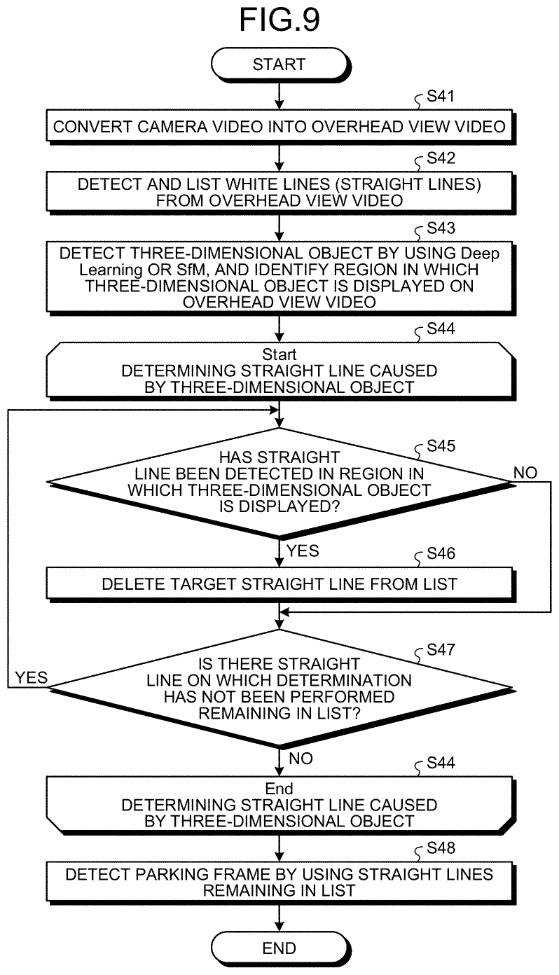

A processing procedure for detecting a parking frame according to the fourth embodiment will now be described with reference to a flowchart illustrated in FIG. 9. FIG. 9 is a flowchart illustrating a processing procedure for detecting a parking frame according to the fourth embodiment.

The image processing device 100 converts the captured image (camera video) acquired from the camera 6 into an overhead view image/video (step S41). The image processing device 100 then detects and lists white lines (straight lines) from the overhead view image (step S42). The image processing device 100 detects the three-dimensional object by using such as deep learning or Structure form Motion (SfM), and identifies the region in which the three-dimensional object is displayed on the overhead view video (step S43).

The image processing device 100 then performs loop processing to determine a straight line caused by the three-dimensional object in the overhead view image (step S44).

The image processing device 100 performs loop processing for each of the listed straight lines. In the loop processing, the processing of step S45 to step S47 is performed. In step S45, it is determined whether or not the target straight line corresponds to the region of the three-dimensional object (i.e., whether a straight line is detected in a region in which the three-dimensional object is displayed). If the target straight line corresponds to the region of the three-dimensional object (step S45: Yes), the target straight line is deleted from the list (step S46), and the process proceeds to step S47. If the target straight line does not correspond to the region of the three-dimensional object (step S45: No), the target straight line is not deleted from the list and the process proceeds to step S47.

If there is a straight line on which the determination processing of step S45 has not been performed among the straight lines in the list (step S47: Yes), the image processing device 100 proceeds to step S45 and performs the determination processing on the straight line on which the determination processing is not performed. If there is no straight line on which the determination processing of step S45 has not been performed among the straight lines in the list (step S47: No), the loop processing is ended and the process proceeds to step S48. In step S48, the image processing device 100 detects a parking frame by using the straight lines remaining in the list (step S48).

The image processing device 100 according to the fourth embodiment identifies a three-dimensional object portion from a captured image, removes a straight line corresponding to the three-dimensional object portion among straight lines detected from an overhead view image, and extracts a parking frame from the remaining straight lines.

As described above, the image processing device 100 removes the straight line corresponding to the three-dimensional object portion among the straight lines detected from the overhead view image to extract a parking frame, and thus can appropriately extract the parking frame.

### Fifth Embodiment

The image processing device 100 according to a fifth embodiment detects a three-dimensional object from a captured image of the vehicle 1, deletes a three-dimensional object region from the captured image to convert the captured image into an overhead view image, detects a straight line from the overhead view image, and extracts a parking frame from the detected straight line.

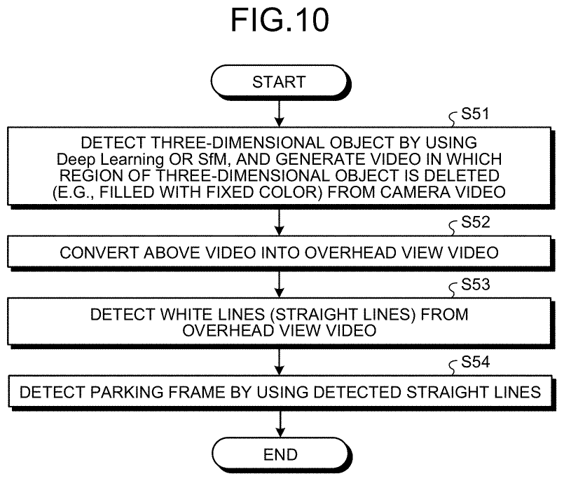

A processing procedure for detecting a parking frame according to the fifth embodiment will now be described with reference to a flowchart illustrated in FIG. 10. FIG. 10 is a flowchart illustrating a processing procedure for detecting a parking frame according to the fifth embodiment.

The image processing device 100 detects a three-dimensional object from the captured image by using deep learning (or SfM), for example, and generates an image (video) from which the three-dimensional object portion of the captured image is deleted (in which the region of the three-dimensional object is deleted (e.g., filled with fixed color) from the camera video) (step S51). The image processing device 100 converts the generated image (the above video) into an overhead view video (step S52). The image processing device 100 detects white lines (straight lines) from the overhead view image (step S53) and detects a parking frame by using the detected straight line (step S54).

The image processing device 100 according to the fifth embodiment identifies a three-dimensional object portion from a captured image, generates an image from which the three-dimensional object portion is removed, converts the image into an overhead view image, detects a straight line from the overhead view image, and extracts a parking frame from the detected straight line.

As described above, the image processing device 100 converts the image from which the three-dimensional object portion is deleted into an overhead view image and detects a straight line, so that the three-dimensional object portion is not detected as a straight line, and the image processing device can appropriately extract a parking frame.

The image processing device according to the present disclosure thus can appropriately detect the parking frame line from the overhead view image.

While the embodiments of the present disclosure have been described above, the embodiments described above have been presented by way of example only, and are not intended to limit the scope of the invention. These novel embodiments may be practiced in a variety of other forms, and various omissions, substitutions and changes may be made to an extent without departing from the spirit of the invention. These novel embodiments and variations thereof are included in the scope and spirit of the invention, and are also included in the invention described in the claims and the scope of equivalents thereof. Further, the components throughout different embodiments and modifications may be combined as appropriate.

The notation “ . . . part” in the above-described embodiments may be replaced with other notations such as “ . . . circuitry”, “ . . . assembly”, “ . . . device”, “ . . . unit”, or “ . . . module”.

In each of the above embodiments, an example in which the present disclosure is configured using hardware has been described, but the present disclosure can also be implemented by software in cooperation with hardware.

Each of functional blocks used for the description of each of the above embodiments is typically implemented as an LSI which is an integrated circuit. The integrated circuit controls each of functional blocks used for the description of the above embodiments, and may include an input terminal and an output terminal. These integrated circuits may be individually formed into one chip, or may be formed into one chip so as to include a part or all of the integrated circuits. The integrated circuit is herein referred to as an LSI, but may be referred to as an IC, a system LSI, a super LSI, or an ultra LSI, depending on a difference of a degree of integration.

The method of circuit integration is not limited to an LSI, and may be implemented by using a dedicated circuit or a general-purpose processor and memory. Circuit integration may use a field programmable gate array (FPGA) that is programmable after manufacture of an LSI or a reconfigurable processor in which connections or settings of circuit cells within the LSI are reconfigurable.

Further, if an integrated circuit technology that replaces the LSI appears due to the progress of the semiconductor technology or another derived technology, the functional blocks may be obviously integrated by using the technology. For example, application of biotechnology is also a possibility.

The effects in the embodiments described herein are merely examples and not limited, and may have other effects.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processing device comprising:
one or more hardware processors configured to function as:
a generation unit that generates an overhead view image in which a captured image capturing a periphery of a vehicle is converted into an image from a viewpoint above the vehicle;
a detection unit that detects a straight line from the overhead view image; and
a parking frame extraction unit that extracts a parking frame based on straight lines obtained by excluding straight lines matching a predetermined removal condition among straight lines detected by the detection unit.

2. The image processing device according to claim 1, wherein the parking frame extraction unit sets a straight line extending radially based on an imaging reference location among straight lines detected by the detection unit as a straight line matching the predetermined removal condition.

3. The image processing device according to claim 1, wherein
the generation unit generates an overhead view image of each of a first captured image at a first time point during movement of a vehicle and a second captured image at a second time point after the first time point,
the detection unit detects a straight line from each of an overhead view image based on the first captured image and an overhead view image based on the second captured image, and calculates a feature amount of each straight line, and
the parking frame extraction unit sets a straight line having no feature amount of the straight line of the overhead view image based on the second captured image and corresponding to a result obtained by correcting the feature amount of the straight line of the overhead view image based on the first captured image based on the movement amount of the vehicle, as the straight line matching the predetermined removal condition.

4. The image processing device according to claim 1, wherein
the generation unit generates an overhead view image of each of a third captured image captured in a front-rear direction of the vehicle and a fourth captured image captured in a left-right direction of the vehicle,
the detection unit detects a straight line from each of an overhead view image based on the third captured image and an overhead view image based on the fourth captured image, and calculates a feature amount of each straight line, and
the parking frame extraction unit sets a straight line having no feature amount of the straight line of the overhead view image based on the fourth captured image and corresponding to the feature amount of the straight line of the overhead view image based on the third captured image, as the straight line matching the predetermined removal condition.

5. The image processing device according to claim 1, wherein the parking frame extraction unit sets a straight line corresponding to a region of a three-dimensional object detected from the captured image among straight lines detected by the detection unit as a straight line matching the predetermined removal condition.

6. An image processing device comprising:
one or more hardware processors configured to function as:
a generation unit that generates an overhead view image in which an image obtained by deleting a region of a three-dimensional object from a captured image capturing a periphery of a vehicle is converted into an image from a viewpoint above the vehicle;
a detection unit that detects a straight line from the overhead view image; and
a parking frame extraction unit that extracts a parking frame based on a straight line detected by the detection unit.

7. An image processing method implemented by an image processing device that includes one or more hardware processors and that processes an image capturing a periphery of a vehicle, the image processing method comprising:
generating an overhead view image in which a captured image capturing a periphery of the vehicle is converted into an image from a viewpoint above the vehicle;
detecting a straight line from the overhead view image; and
extracting a parking frame based on straight lines obtained by excluding straight lines matching a predetermined removal condition among straight lines detected in the detecting.

8. An image processing method implemented by an image processing device that includes one or more hardware processors and that processes an image capturing a periphery of a vehicle, the image processing method comprising:
generating an overhead view image in which an image obtained by deleting a region of a three-dimensional object from a captured image capturing a periphery of the vehicle is converted into an image from a viewpoint above the vehicle;
detecting a straight line from the overhead view image; and
extracting a parking frame based on a straight line detected in the detecting.
